(19) United States
(12) Patent Application Publication
(10) Pub. No.: US 2007/0121876 A1
(43) Pub. Date: May 31, 2007

(54) System for managing the transfer of a call waiting party into an existing subscriber call connection to replace a terminal device on the existing call connection

(75) Inventor: Mark Alan McCormick, Naperville, IL (US)

Correspondence Address: PATTON BOGGS, 1660 LINCOLN ST, SUITE 2050, DENVER, CO, 80264, US

(73) Assignee: Lucent Technologies, Inc., Murray Hill, NJ (US)

(21) Appl. No.: 11/267,449

(22) Filed: Nov. 4, 2005

(51) Int. Cl. H04M 3/42

(52) U.S. Cl. 379/215.01

(57) ABSTRACT

The system for transferring a call connection to a call waiting party operates when an incoming call is directed to one of the parties on the existing call connection. The called party receives an indication of the incoming call and flashes the switch-hook on their terminal device to place the other party on the existing call connection on hold and also to pick up the incoming call After speaking with the calling party, the called party determines that the calling party should communicate with only the other party on the existing call connection, who is presently on hold. The called party then operates their terminal device by inputting specific digits or a code to activate the system for transferring a call connection to a call waiting party which responds by maintaining the existing call connection while adding the calling party to the existing call connection and disconnecting the called party from the existing call connection.

### CROSS REFERENCE TO RELATED APPLICATIONS

This application is related to a U.S. patent application titled “System For Managing The Addition Of A Call Waiting Party To An Existing Subscriber Call Connection” and filed on the same date as the present application.

### FIELD OF THE INVENTION

This invention relates to communication networks and the management of existing call connections with respect to call waiting call parties.

### BACKGROUND OF THE INVENTION

It is a problem in the field of communication networks to enable a subscriber, who is a call waiting party on an existing call connection, to replace one of the two parties on the existing call connection.

Presently, when a party who is on an existing call connection has a third party in a call waiting mode, there is no ability to enable one of the two parties on the existing call connection to drop off the call and replace this party with the call waiting party. The addition of another (third) party into an existing call connection can only occur in the present telephone network in the form of one of the two parties on the existing call connection initiating Three Way Calling and calling the third party. The Three Way Calling feature adds the third party to the existing call connection but cannot respond to a third party calling in to one of the two parties on an existing call connection. Therefore, the existing communication network is unable, in an existing call connection with a call waiting party, to enable one of the two parties on the existing call connection to drop off the call and replace this party with the call waiting party.

### BRIEF SUMMARY OF THE INVENTION

The above-described problems are solved and a technical advance achieved by the present System For Managing The Transfer Of A Call Waiting Party Into An Existing Subscriber Call Connection To Replace A Terminal Device On The Existing Call Connection, herein termed “system for transferring a call connection to a call waiting party”. This system enables a party on the existing call connection who receives an incoming call from a third party to drop off the existing call connection and be replaced with the third party without disrupting the existing call connection.

The system for transferring a call connection to a call waiting party operates when an incoming call is directed to one of the parties on the existing call connection. The called party receives an indication of the incoming call and flashes the switch-hook on their terminal device to place the other party on the existing call connection on hold and also to pick up the incoming call. After speaking with the calling party, the called party determines that the calling party should communicate with only the other party on the existing call connection, who is presently on hold. The called party can place the calling party (also termed “call waiting party”) on hold to confer with the other party on the existing call connection before adding the call waiting party into the existing call connection.

The process of transferring a call connection to a call waiting party can be realized in two different ways. The called party can operate their terminal device by inputting specific digits or a code to activate the system for transferring a call connection to a call waiting party which responds by maintaining the existing call connection while adding the calling party to the existing call connection and disconnecting the called party from the existing call connection. Two parties are then on the call connection—the calling party and the other party on the existing call connection—and these two parties continue to converse until one of the two parties disconnects from the call, creating the billing record and releasing the call resources. Alternatively, the called party can dial a predetermined code to connect the call waiting party into a three way call and then subsequently enter a predetermined code to drop the called party from the call connection, allowing the other party from the original call connection and the call waiting party to continue on the call. In both cases the party dropping out can make and receive calls without interference from the call connection from which they disconnected.

### BRIEF DESCRIPTION OF THE DRAWINGS

FIG. 1 illustrates, in block diagram form, the overall architecture of a telephone network and a typical call connection that uses the present system for transferring a call connection to a call waiting party, and

FIG. 2 illustrates, in flow diagram form, the operational steps taken by the present system for transferring a call connection to a call waiting party to implement a call transfer for a terminal device.

### DETAILED DESCRIPTION OF THE INVENTION

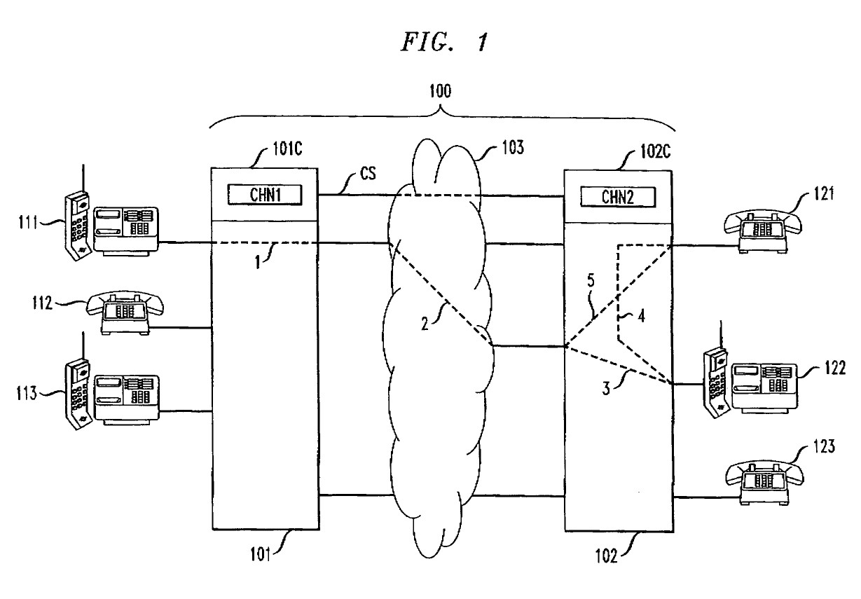

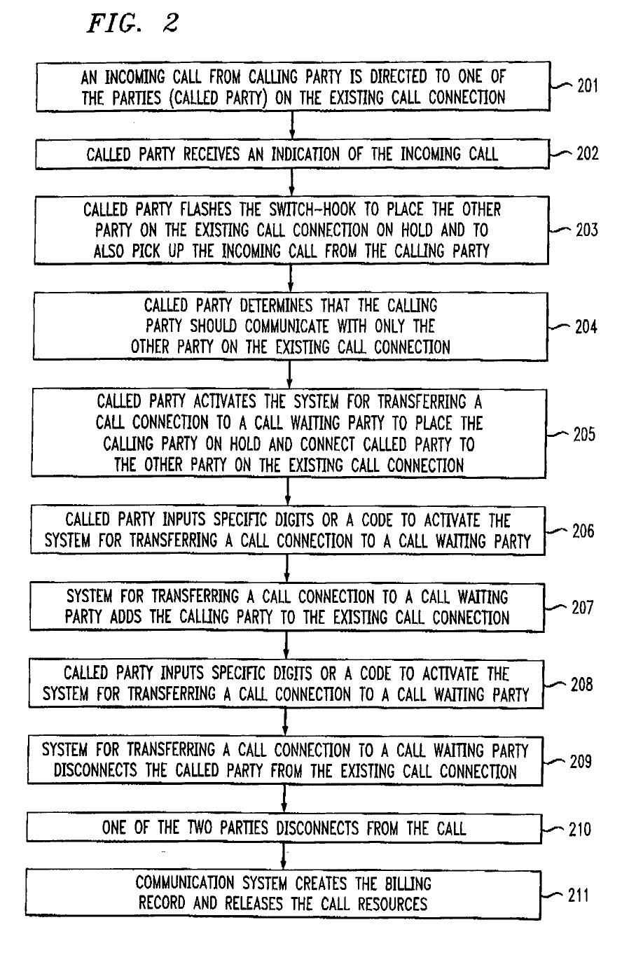

FIG. 1 illustrates, in block diagram form, the overall architecture of a telephone network and a typical call connection that uses the present system for transferring a call connection to a call waiting party; and FIG. 2 illustrates, in flow diagram form, the operational steps taken by the present system for transferring a call connection to a call waiting party to implement a call transfer for a terminal device.

The communications network comprises a traditional voice communications network that includes a plurality of local communications systems 101,102, which could be a PSTN land configuration, wireless configuration or a combination of the two, such as telephone switching systems that are part of the Public Switched Telephone Network (PSTN) 100 and are interconnected via trunk circuits (or an IP connection) to an Inter-Exchange Carrier System (IXC) 103. Each of the communications systems 101, 102 serve a plurality of terminal devices 111-113, 121-123, respectively, and the communications systems 101, 102 may be interconnected via an out-of-band signaling link CS through the Inter-Exchange Carrier System (IXC) 103, using the well-known SS7 signaling protocol or the IP protocol. The operation of such a communications network is well known and is not described in detail herein. The communications systems 101, 102 provide a set of features and services to the terminal devices that they serve, including a system for transferring a call connection to a call waiting party wherein the communications systems 101, 102 implement the call transfer function for the associated terminal devices in response to control signals that are received from the terminal devices. In addition, the communications systems 101, 102 are both equipped with the system for transferring a call connection to a call waiting party CHN1, CHN2, that are operational in the controllers 101C, 102C of the respective communications systems 101, 102.

For the purpose of illustration, the call connection used to describe the operation of the present system for transferring a call connection to a call waiting party CHN2 consists of terminal device 111 connected to terminal device 122. The connection extends from terminal device 111 through communication system 101 (path 1), Inter-Exchange Carrier System (IXC) 103 (path 2), communication system 102 (path 3), to terminal device 122. The use of multiple communication systems and the Inter-Exchange Carrier System (ICX) for the call connection is not a limitation on the operation of the system for transferring a call connection to a call waiting party CHN2, since the call connection can be solely within communication system 102, or may include one or more mobile terminal devices and their associated Mobile Switching Centers (not shown).

In this environment, the only way to add a third party to the existing call connection or to substitute a third party for one of the two parties on the existing call connection is to use the Three Way Calling feature. The Three Way Calling feature is initiated when one of the two parties (first party) on the existing call connection flashes the switch-hook to place the other party on hold and initiates a call to the third party. The third party is then connected to the first party, who can again flash the switch-hook to add the third party to the existing call connection. Unfortunately, this feature is only outbound capable, in that one of the two parties on the existing call connection is the only one who can contact the third party.

The system for transferring a call connection to a call waiting party operates to enable a third party (calling party to contact one party on an existing call connection and be substituted for that party on the existing call connection. This process is initiated when, at step 201, an incoming call from calling party located at terminal device 121 is directed to the terminal device 122 of one of the parties (called party) on the existing call connection (paths 1-3). The called party receives an indication of the incoming call on their terminal device 122 at step 202 and flashes the switch-hook of their terminal device 122 (or generates some other control signal) at step 203 to place the terminal device 111 of the other party on the existing call connection on hold and to also pick up the incoming call from the calling party by connecting the terminal device 121 of the calling party to the terminal device 122 of the called party over path 4. After speaking with the calling party, the called party at step 204 determines that the calling party should communicate with only the other party on the existing call connection, who is presently on hold. The called party then operates their terminal device 122 at step 205 to place the calling party (also termed “call waiting party”) on hold to confer with the other party on the existing call connection before adding the call waiting party into the existing call connection.

The process of transferring a call connection to a call waiting party can be realized in two different ways. The called party can dial a predetermined code to connect the call waiting party into a three way call and then subsequently enter a predetermined code to drop the called party from the call connection, allowing the other party from the original call connection and the call waiting party to continue on the call. Alternatively, the called party can dial a predetermined code to connect the call waiting party into the call connection and to drop the called party from the call connection, allowing the other party from the original call connection and the call waiting party to continue on the call. Since the second case is a subset of the first case, the three way connection is described herein, with the realization that the process can be implemented by simply jumping to step 207.

The called party then operates their terminal device 122 at step 206 by inputting specific digits or a code to activate the system for transferring a call connection to a call waiting party CHN2, which responds by maintaining paths 1-2 of the existing call connection while adding the terminal device 121 of the calling party to the existing call connection via path 5 at step 207. The three parties are then all connected and can converse until the called party at step 208 operates their terminal device 122 to input specific digits or a code to activate the system for transferring a call connection to a call waiting party CHN2, which responds by disconnecting the terminal device 122 of the called party from the existing call connection at step 209.

Two parties are then on the call connection (paths 1, 2, 5)—the calling party at terminal device 121 and the other party on the existing call connection at terminal device 111—and these two parties continue to converse until one of the two parties disconnects from the call at step 210, creating the billing record and releasing the call resources at step 211. Alternatively, one of these two parties can receive an incoming call and the above-described process can be repeated, where the calling party is added to the existing call connection or a three way call can be created.

This service is beneficial in the case of a service dispatcher (called party), where a service personnel calls in to the dispatcher and a third party customer (calling part) is added to the call, and the service personnel and customer converse without the need for the dispatcher being involved.

### SUMMARY

The system for transferring a call connection to a call waiting party enables a party on the existing call connection who receives an incoming call from a third party to drop off the existing call connection and be replaced with the call waiting party without disrupting the existing call connection.

What is claimed as new and desired to be protected by Letters Patent of the United States is:

1. A system for transferring a call connection to a call waiting party comprising:
incoming call processing means, responsive to an incoming call from a calling party directed to a one of a first party and a second party engaged in an existing subscriber call connection, for generating an alert indication at the one of a first terminal device and a second terminal device associated with said one of a first party and a second party, and
called party substitution means, responsive to said one of said first party and said second party inputting a predetermined code into the respective one of said first terminal device and said second terminal device, for substituting said calling party for said one of said first party and said second party on said existing call connection.

2. The system for adding a call waiting party to an existing call connection of claim 1, wherein said called party substitution means comprises:
calling party addition means, responsive to said one of said first party and said second party inputting a predetermined code into the respective one of said first terminal device and said second terminal device, for adding said calling party to said existing call connection; and
disconnect means, responsive to said one of said first party and said second party inputting a predetermined code into the respective one of said first terminal device and said second terminal device, for releasing said one of said first party and said second party from said call connection.

3. The system for adding a call waiting party to an existing call connection of claim 1, further comprising:
disconnect means, responsive to a one of said calling party and said other of said first party and said second party disconnecting from said existing call connection, for releasing said call connection.

4. The system for adding a call waiting party to an existing call connection of claim 1, further comprising:
call hold means, responsive to said one of a first party and a second party flashing the switch-hook on their associated terminal device in response to receipt of said alert indication, for placing the other of said first party and a second party on hold.

5. The system for adding a call waiting party to an existing call connection of claim 4, further comprising:
calling party means, responsive to said one of a first party and a second party flashing the switch-hook on their associated terminal device in response to receipt of said alert indication, for connecting said calling party with said one of said first party and a second party.

6. The method of adding a call waiting party to an existing call connection between a first party located at a first terminal device and a second party located at a second terminal device, comprising:
generating, in response to an incoming call directed to a one of a first party and a second party engaged in an existing subscriber call connection, an alert indication at the one of said first terminal device and said second terminal device associated with said one of a first party and a second party, and
substituting, in response to said one of said first party and said second party inputting a predetermined code into the respective one of said first terminal device and said second terminal device, said calling party for said one of said first party and said second party on said existing call connection.

7. The method of adding a call waiting party to an existing call connection of claim 6, wherein said step of substituting comprises:
adding, in response to said one of said first party and said second party inputting a predetermined code into the respective one of said first terminal device and said second terminal device, said calling party to said existing call connection; and
releasing, in response to said one of said first party and said second party inputting a predetermined code into the respective one of said first terminal device and said second terminal device, said one of said first party and said second party from said call connection.

8. The method of adding a call waiting party to an existing call connection of claim 7, further comprising:
releasing, in response to a one of said calling party and said other of said first party and said second party disconnecting from said existing call connection, for releasing said call connection.

9. The method of adding a call waiting party to an existing call connection of claim 7, further comprising:
placing, in response to said one of a first party and a second party flashing the switch-hook on their associated terminal device in response to receipt of said alert indication, the other of said first party and a second party on hold

10. The method of adding a call waiting party to an existing call connection of claim 9, further comprising:
connecting, in response to said one of a first party and a second party flashing the switch-hook on their associated terminal device in response to receipt of said alert indication, said calling party with said one of said first party and a second party
